(19) United States
(12) Patent Application Publication
(10) Pub. No.: US 2024/0408966 A1
(43) Pub. Date: Dec. 12, 2024

(54) CORROSION-RESISTANT TROLLEY WHEEL

(71) Applicant: Omco Sumo, Inc., Waukesha, WI (US)

(72) Inventor: Kyle C. Stoehr, Okauchee, WI (US)

(21) Appl. No.: 18/735,795

(22) Filed: Jun. 6, 2024

Related U.S. Application Data
(60) Provisional application No. 63/507,054, filed on Jun. 8, 2023.

(51) Int. Cl. B60L 5/06; B65G 17/20

(52) U.S. Cl. CPC B60L 5/06; B65G 17/20

(57) ABSTRACT

A trolley wheel for use in a conveyor system, the trolley wheel comprising a central shaft, a wheel body, first and second rows of ball bearings, and an inner race. The wheel body and the inner race both comprise a polymer in combination with the trolley wheel being devoid of a metal inner race and being devoid of a metal outer race. The wheel body defines a central rim with opposed first and second sides that respectively define first and second outwardly-angled outer race tracks. The inner race defines first and second inwardly-angled inner race tracks, such that the first row of ball bearings is configured to roll between the first inwardly-angled inner race track and the first outwardly-angled outer race track, and the second row of ball bearings is configured to roll between the second inwardly-angled inner race track and the second outwardly-angled outer race track.

### RELATED APPLICATIONS

This application claims priority to U.S. provisional patent application No. 63/507,054, filed Jun. 8, 2023, the entire contents of which are incorporated herein by reference.

### FIELD

The various embodiments herein relate to trolley wheels for use in a conveyor system, such as an overhead conveyor system in a poultry processing facility.

### BACKGROUND

Overhead trolley conveyor systems are used in various settings, including poultry processing plants. Conveyor systems can include tracks, trolley assemblies which ride the tracks, and drive mechanisms (e.g., comprising chains) that move the trolleys along the tracks. A basic trolley assembly includes one or more trolley wheel assemblies, which roll on a track, and a bracket capable of suspending an item (e.g., poultry) from the track. Different trolley wheel assemblies are used depending upon the particular setting and performance requirements, but in general, a trolley wheel assembly includes a wheel and some form of bearing assembly.

During use, trolley assemblies are often subjected to environments in which the wheel assemblies get dirty over a period of time. This can degrade performance. Debris and other contaminants may enter and become lodged within the bearing assembly. This can affect the life of the assembly and its operational quality. Such debris can be difficult to remove. It is therefore common to periodically clean trolley wheels using water and/or antimicrobial agents, such as peracetic acid. Trolley wheels with metal races corrode over time. Moreover, such trolley wheels may require substantial lubrication. Corrosion of metal races and substantial lubrication can lead to other problems that would be desirable to eliminate or address.

### BRIEF SUMMARY

Some embodiments of the invention provide a trolley wheel for use in a conveyor system. The trolley wheel includes a central shaft, a wheel body, first and second rows of ball bearings, and an inner race. The wheel body and the inner race both comprise a polymer in combination with the trolley wheel being devoid of a metal inner race and being devoid of a metal outer race. Preferably, the wheel body defines a central rim with opposed first and second sides that respectively define first and second outwardly-angled outer race tracks. In addition, the inner race preferably defines first and second inwardly-angled inner race tracks. In such cases, the first row of ball bearings is configured to roll between the first inwardly-angled inner race track and the first outwardly-angled outer race track, whereas the second row of ball bearings is configured to roll between the second inwardly-angled inner race track and the second outwardly-angled outer race track.

In certain embodiments, the invention provides a trolley wheel for use in a conveyor system. The trolley wheel includes a central shaft, a wheel body, first and second rows of ball bearings, and an inner race. The wheel body and the inner race both comprise a polymer in combination with the trolley wheel being devoid of a metal inner race and being devoid of a metal outer race. In the present embodiments, the first and second rows of ball bearings comprise non-metal (e.g., ceramic) ball bearings and are devoid of a ball bearing retainer. Preferably, the wheel body defines a central rim with opposed first and second sides that respectively define first and second outwardly-angled outer race tracks. In addition, the inner race preferably defines first and second inwardly-angled inner race tracks. In such cases, the first row of ball bearings is configured to roll between the first inwardly-angled inner race track and the first outwardly-angled outer race track, whereas the second row of ball bearings is configured to roll between the second inwardly-angled inner race track and the second outwardly-angled outer race track.

Certain embodiments of the invention provide a trolley wheel for use in a conveyor system. The trolley wheel includes a central shaft, a wheel body, first and second rows of ball bearings, and an inner race. In the present embodiments, the wheel body and the inner race both comprise an ultra-high molecular weight polyethylene in combination with the trolley wheel being devoid of a metal inner race and being devoid of a metal outer race. Furthermore, the first and second rows of ball bearings can advantageously comprise ceramic ball bearings. The wheel body preferably defines a central rim with opposed first and second sides that respectively define first and second outwardly-angled outer race tracks. In addition, the inner race preferably defines first and second inwardly-angled inner race tracks. In such cases, the first row of ball bearings is configured to roll between the first inwardly-angled inner race track and the first outwardly-angled outer race track, whereas the second row of ball bearings is configured to roll between the second inwardly-angled inner race track and the second outwardly-angled outer race track.

In some embodiments, the invention provides a trolley wheel for use in a conveyor system. The trolley wheel includes a central shaft, a wheel body, first and second rows of ball bearings, and an inner race. The wheel body and the inner race both comprise polymer in combination with the trolley wheel being devoid of a metal inner race and being devoid of a metal outer race. Preferably, the inner race is a split inner race that includes first and second annular inner race bodies, both of which preferably are machined polymer bodies.

Some embodiments of the invention provide a trolley wheel for use in a conveyor system. The trolley wheel includes a central shaft, a wheel body, first and second rows of ball bearings, and an inner race. The wheel body and the inner race both comprise polymer in combination with the trolley wheel being devoid of a metal inner race and being devoid of a metal outer race. In the present embodiments, the polymer of the inner race preferably includes a lubricant additive.

While multiple embodiments are disclosed, other embodiments will become apparent to those skilled in the art from the following detailed description, which shows and describes illustrative embodiments. As will be realized, the various implementations are capable of modifications in various apparent aspects, all without departing from the spirit and scope thereof. Accordingly, the drawings and detailed description are to be regarded as illustrative in nature and not restrictive.

### BRIEF DESCRIPTION OF THE DRAWINGS

FIG. 1A and FIG. 1B are a front view and a cross-sectional side view, respectively, of a trolley wheel and trolley bracket assembly in accordance with certain embodiments of the invention.

FIG. 2 is an exploded perspective view of an embodiment of a trolley wheel in accordance with some embodiments of the invention.

FIG. 3A and FIG. 3B are a front view and a cross-sectional side view, respectively, of the trolley wheel of FIG. 2.

FIG. 4 is an exploded perspective view of another embodiment of a trolley wheel.

FIG. 5A and FIG. 5B are a front view and a cross-sectional side view, respectively, of the trolley wheel of FIG. 4.

FIG. 6A and FIG. 6B are a front view and a cross-sectional side view, respectively, of still another embodiment of the trolley wheel.

### DETAILED DESCRIPTION

The various embodiments herein relate to trolley wheels for use in a conveyor system.

One exemplary embodiment of the invention provides a trolley wheel 12 for use in a conveyor system, such as an overhead conveyor system. The trolley wheel 12 includes a central shaft 20, a wheel body 14, first and second rows of ball bearings 16A, 16B, and an inner race 18. Preferably, the trolley wheel 12 is devoid of a metal inner race and is devoid of a metal outer race. In addition, the wheel body 14 and the inner race 18 desirably both comprise polymer.

Thus, the wheel body 14 and the inner race 18 can both comprise (or consist essentially of, or consist of) polymer. In some embodiments, the inner race 18 comprises (or consists essentially of, or consists of) ultra-high molecular weight polyethylene. Suitable UHMW-PE is commercially available from the Mitsubishi Chemical Group (Tokyo, Japan), e.g., under the trade name TIVAR. In addition, suitable UHMW-PE is commercially available from Roechling Industrial Gastonia (Dallas, North Carolina, U.S.A.), e.g., under the trade name LubX. When provided, the UHMW-PE can optionally have a dry lubricant composition. One such material is commercially available from the Mitsubishi Chemical Group under the trade name TIVAR HPV. Another such material is commercially available from Rocchling Industrial Gastonia under the trade name LubX C. Alternatively, the inner race 18 can be made of other materials. For example, various other polymers can be used, such as polyoxymethylene (“acetal”), polypropylene, or nylon. In some cases, glass filled acetal is used, such as acetal with a 30% glass fill.

In one group of embodiments, the inner race 18 and the wheel body 14 both comprise UHMW-PE. In another group of embodiments, the inner race 18 comprises UHMW-PE and the wheel body comprises polyoxymethylene. In both of these embodiment groups, the UHMW-PE of the inner race 18 can optionally comprise a dry lubricant additive. Additionally or alternatively, in both of these embodiment groups, the inner race 18 can be a machined body. Furthermore, if desired, the ball bearings in both of these embodiment groups can be non-metal (e.g., ceramic) ball bearings, although conventional metal ball bearings can alternatively be used.

In some embodiments, the wheel body 14 and the inner race 18 each have a dynamic coefficient of friction (QTM 55007 (20)) that is less than 0.25, less than 0.20, or even less than 0.15. Providing the wheel body 14 (or at least outwardly-angled race tracks 26A, 26B thereof) with such a low friction surface can provide exceptional bearing performance. Additionally or alternatively, providing the inner race 18 (or at least inwardly-angled race tracks 28A, 28B thereof) with such a low friction surface can provide exceptional bearing performance. Some preferred embodiments of this nature use UHMW-PE having a lubricant additive. One suitable example is the above-noted TIVAR HPV material.

In any embodiment of the present disclosure, the polymer of the inner race 18 can optionally comprise a lubricant additive. In certain embodiments of this nature, the polymer of the wheel body 14 is devoid of the lubricant additive. When provided, the lubricant additive preferably is selected from the group consisting of molybdenum disulfide, tungsten disulfide, graphite, calcium stearate, polytetrafluoroethylene, and oil. If desired, the polymer of the inner race 18 can be UHMW-PE that includes the lubricant additive. UHMW-PE products that include various lubricant additives are commercially available from Mitsubishi Chemical Group, Rocchling Industrial Gastonia, Polymer Industries (Henagar, Alabama, U.S.A.), or other commercial suppliers.

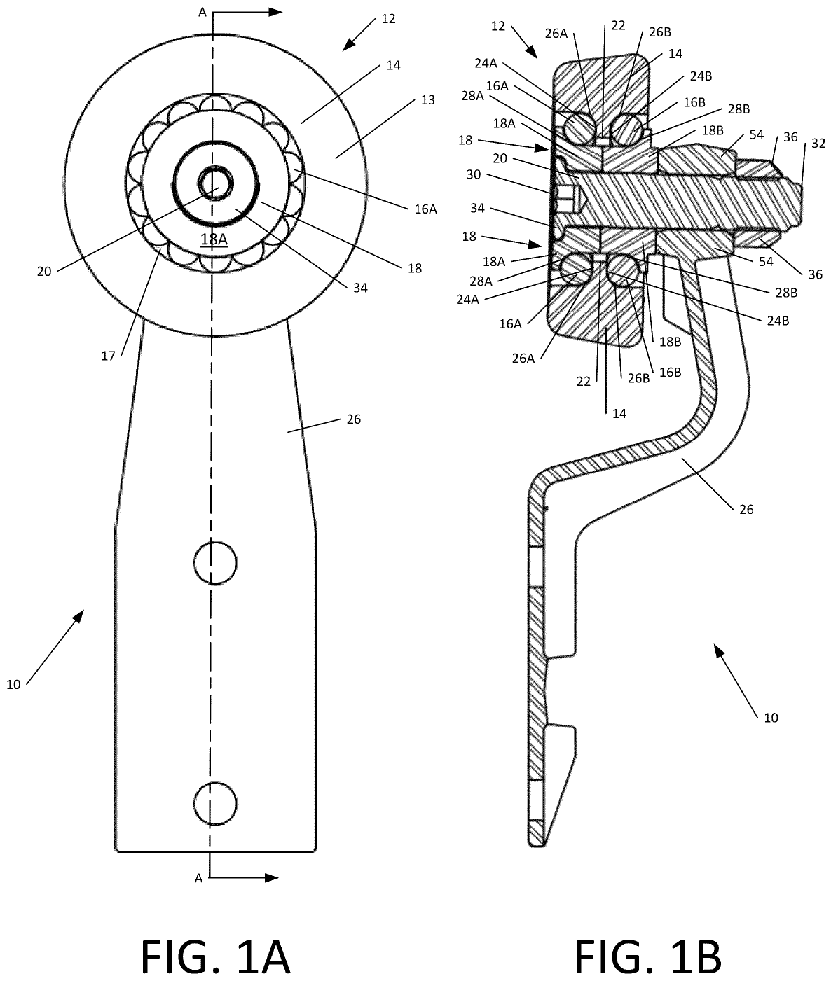

The wheel body 14 can have various characteristics. For example, the wheel body 14 can optionally define a central rim 22 with opposed first and second sides 24A, 24B. In such cases, the opposed first and second sides 24A, 24B can respectively define first and second outwardly-angled outer race tracks 26A, 26B. Further, the inner race 18 can define first and second inwardly-angled inner race tracks 28A, 28B. In embodiments of this nature, the first row of ball bearings 16A can be configured to roll between the first inwardly-angled inner race track 28A and the first outwardly-angled outer race track 26A, whereas the second row of ball bearings 16B can be configured to roll between the second inwardly-angled inner race track 28B and the second outwardly-angled outer race track 26B. This is perhaps best appreciated by referring to the non-limiting examples of FIGS. 1B, 3B, 5B, and 6B.

In embodiments where the polymer of the inner race 18 comprises a lubricant additive (including such embodiments wherein the polymer of the wheel body 14 is devoid of the lubricant additive), normal operation of the trolley wheel can advantageously produce a transfer film on the ball bearings 16A, 16B and/or on the first and second outwardly-angled outer race tracks. Such a transfer film may also result on the first and second inwardly-angled inner race tracks. The transfer film can result from the lubricant additive in the polymer of the inner race 18 being worn from and thereby emitted (e.g., in the form of particles) from the inner race during normal operation. In embodiments of this nature, the transfer film comprises the lubricant additive. In more detail, the transfer film preferably is formed by particles comprising the lubricant additive. Such particles may form a continuous layer, or the film may comprise areas of particles dispersed non-uniformly, such as where more particles are disposed in certain areas.

In some embodiments, the optional central rim 22 has a butte configuration characterized by (i) a flat top facing radially inwardly toward the inner race 18, and (ii) first 24A and second 24B sides that extend into divergent first and second curves. These divergent first and second curves respectively define the first and second outwardly-angled outer race tracks 26A, 26B. The first 24A and second sides 24B are opposed, or at least generally opposed. The illustrated sides 24A, 24B are steep first and second sides.

Preferably, the inner race 18 is a split inner race comprising (or consisting of) first and second annular inner race bodies 18A, 18B. These two bodies 18A, 18B can be mounted side-by-side (optionally with nothing between them) on the central shaft 20. Reference is made to the non-limiting examples of FIGS. 1B, 3B, 5B, ad 6B. The central shaft 20 has opposed first and second ends 30, 32. Preferably, the first end 30 of the central shaft 20 has an enlarged head 34. In such cases, the first annular inner race body 18A can be adjacent to the first end of the central shaft 20. In embodiments of this nature, where the first end 30 of the central shaft 20 has an enlarged head 34, the first annular inner race body 18A can be adjacent to the enlarged head 34. Furthermore, the trolley wheel 12 can be devoid of a retainer hub alongside the second annular inner race body 18B.

The inner race 18 can optionally have a different thickness than the wheel body 14. In some embodiments, the inner race 18 has a first thickness, the wheel body 14 has a second thickness, and the first thickness is greater than the second thickness. Here, the first and second thicknesses are measured along a rotation axis along which the central shaft 20 is elongated. In other embodiments, the inner race has the same thickness as (or is thinner than) the wheel body.

In some examples, the trolley wheel 12 consists of the central shaft 20, the wheel body 14, the first and second rows of ball bearings 16A, 16B, and the inner race 18.

The central shaft 20 preferably is formed of metal. In some embodiments, the central shaft 20 comprises steel, such as a plated low carbon alloy steel. This can be, in some embodiments, stainless steel. In other cases, an aircraft metal is used, such as titanium, aluminum, or alloys of such metals.

In certain embodiments, the trolley wheel 12 is mounted on a trolley bracket 26, e.g., such that that the second annular inner race body 18B is carried alongside (e.g., directly alongside) a mount portion 54 of the trolley bracket 26. In FIGS. 1A and 1B, the assembly is devoid of a retainer hub between the second inner race body 18B and the mount portion 54 of the bracket 26. A lock nut 36 can optionally be used to attach the trolley wheel 12 to the bracket 26, e.g., so as to retain the trolley wheel 12 on the bracket 26. As just one example, the lock nut 36 can be formed of medium carbon alloy steel. While FIG. 1B shows a second end region of the central shaft 20 being externally threaded and threadingly engaged with an interiorly-threaded lock nut 36, the wheel assembly can alternatively be coupled with (e.g., fastened to) a bracket by other means, such as a rivet stake or the like.

As noted above, the first and second annular inner race bodies 18A, 18B can be mounted side-by-side on the central shaft 20. In such cases, the first and second annular inner race bodies 18A, 18B can optionally be mounted thereon solely by a press fit of the first and second annular inner race bodies 18A, 18B on the central shaft 20. This is shown, for example, in the non-limiting embodiments of FIGS. 3B and 5B. On an exterior surface area of the central shaft 20 where such an inner race 18 is press fit on, there can optionally be a knurl (or other surface roughening topography) so as to prevent rotation of the inner race relative to the central shaft.

In one group of embodiments, the inner race 18 comprises a first polymer, the wheel body 14 comprises a second polymer, and the first polymer is a different polymer than the second polymer. In such cases, the first polymer can optionally be UHMW-PE, preferably with a lubricant additive. Additionally or alternatively, the second polymer can be polyoxymethylene. In the present embodiment group, the first polymer of the inner race 18 can optionally comprise a lubricant additive. Additionally or alternatively, the inner race 18 can be a machined body. Furthermore, if desired, the ball bearings in this embodiment group can be non-metal (e.g., ceramic) ball bearings, although conventional metal ball bearings can alternatively be used.

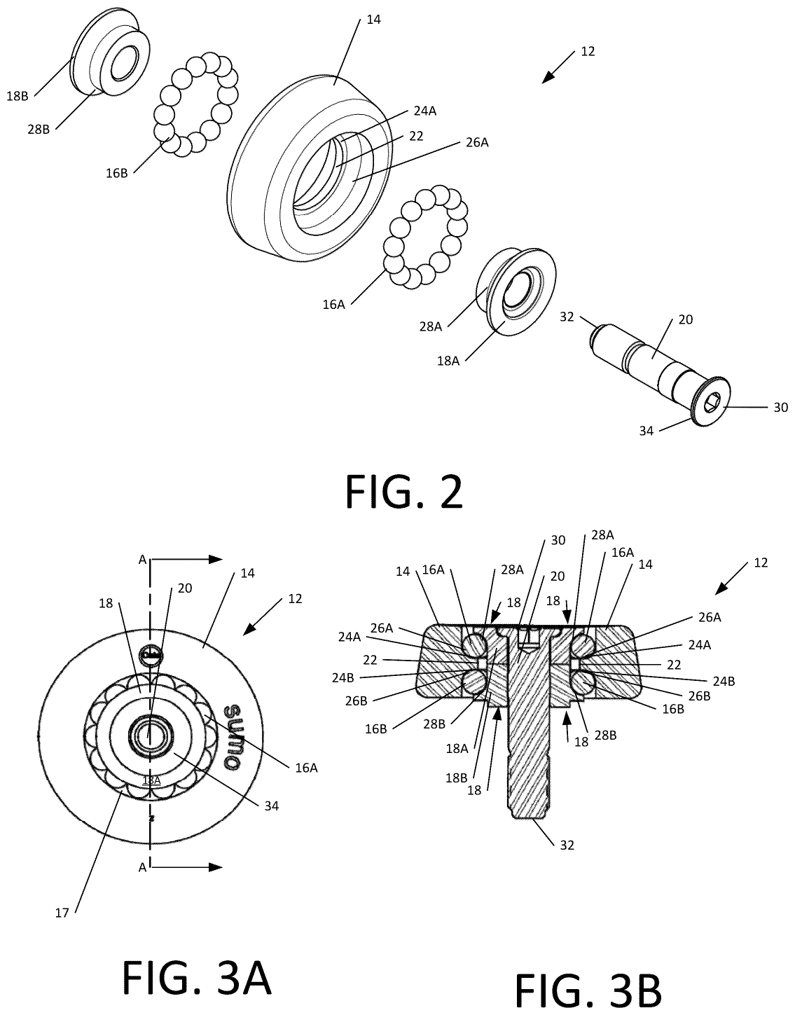

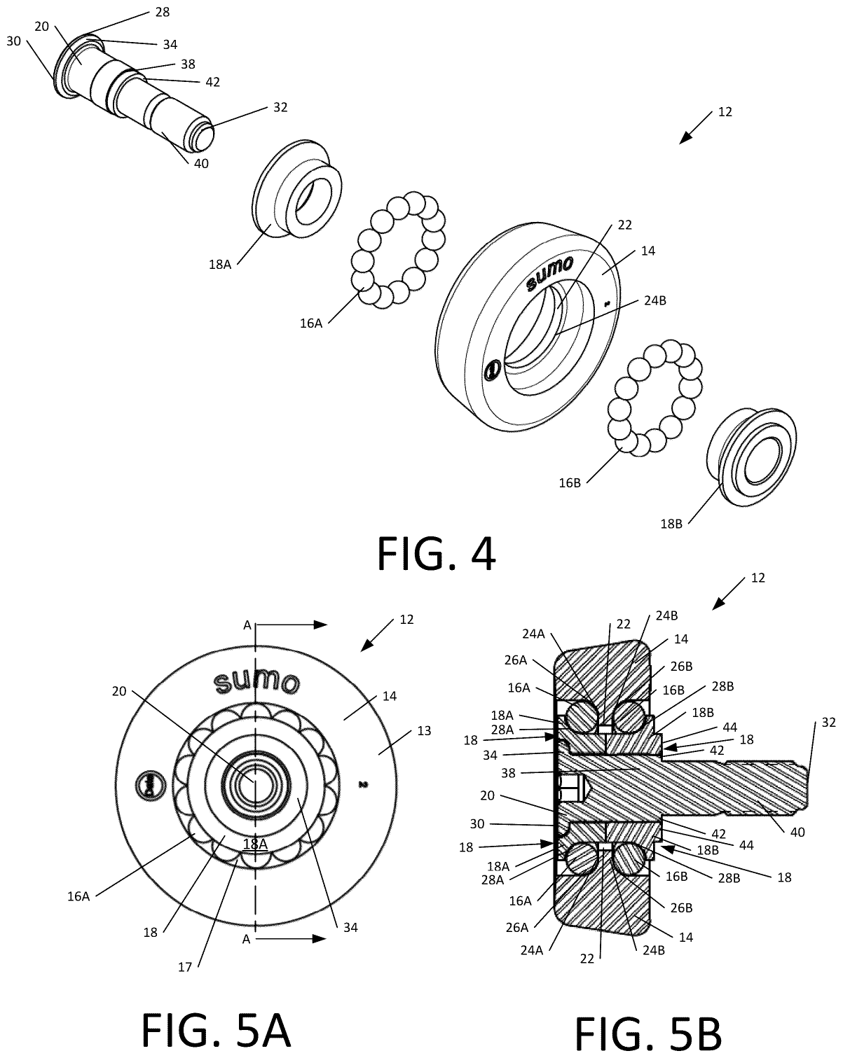

In some embodiments, the first and second rows of ball bearings 16A, 16B are devoid of a ball bearing retainer. This can optionally be the case for any embodiment of the present disclosure. This is perhaps best appreciated by referring to the exploded perspective views of FIGS. 2 and 4.

In certain embodiments, the first and second rows of ball bearings 16A, 16B comprise non-metal ball bearings. Such non-metal ball bearings, for example, can comprise ceramic. Some examples of suitable ceramic ball bearings are formed of silicon nitride or zirconia. In embodiments where non-metal (e.g., ceramic) ball bearings are used, the first and second rows of ball bearings 16A, 16B can optionally be devoid of a ball bearing retainer.

In one group of embodiments, the inner race 18 comprises ultra-high molecular weight polyethylene in combination with the two rows of ball bearings 16A, 16B comprising non-metal ball bearings, which may be ceramic, such as silicon nitride or zirconia. In such cases, the ultra-high molecular weight polyethylene can optionally comprise a lubricant additive.

In certain embodiments, the central shaft 20 comprises (e.g., consists of, or at least consists essentially of) metal, the wheel body 14 comprises (e.g., consists of, or at least consists essentially of) polymer, and the inner race 18 comprises (e.g., consists of, or at least consists essentially of) polymer. In such embodiments, the trolley wheel 12 can optionally be characterized by having a wheel face 13 consisting of, moving radially outwardly, a circular metal face portion defined by metal of the central shaft 20, an annular polymer inner face region defined by polymer of the inner race 18, and an annular polymer outer face region defined by polymer of the wheel body 14. A gap 17 can exist between the annular polymer inner face region and the annular polymer outer face region, such that the first row of ball bearings 16A defines ball bearing surfaces that are exposed through such gap 17 at the wheel face 13. In some cases, those ball bearing surfaces are non-metal (e.g., ceramic) surfaces.

The central shaft 20 is elongated along a rotation axis of the wheel. Moreover, a radial axis perpendicular to the rotation axis preferably passes midway between the first and second rows of ball bearings 16A, 16B. The first inwardly-angled inner race track 28A and the first outwardly-angled outer race track 26A are aligned along a bearing angle, such that the bearing angle is offset from the radial axis by an acute angle. Likewise, the second inwardly-angled inner race track 28B and the second outwardly-angled outer race track 26B are aligned along such an acute bearing angle. The acute angle can be between 30 degrees and 60 degrees. For example, the acute angle can be approximately 45 degrees. Providing the trolley wheel 12 with inwardly-angled inner race tracks and outwardly-angled outer race tracks can advantageously provide durability to thrust forces during use.

In some examples, the central shaft 20 includes a first shaft region 38 and a second shaft region 40, with the first shaft region 38 having a greater diameter than the second shaft region 40. Reference is made to the non-limiting example of FIGS. 4-5B. Here, the larger diameter first shaft region 38 serves as a seat on which the inner race 18 is mounted, optionally by a press fit thereon. Furthermore, the illustrated smaller diameter second shaft region 40 is a region of the central shaft 20 configured to be attached to (e.g., received in an opening defined by a mount portion 54 of) a bracket 26. At the location of the central shaft 20 where the diameter transitions from a larger diameter to a smaller diameter, there is a bearing shoulder (or “step”) 42. The first shaft region 38 can optionally span the combined length of the first and second annular inner race bodies 18A, 18B, e.g., such that the bearing shoulder 42 is flush with an outer face 44 of the second annular inner race body 18B. Reference is made to the non-limiting example of FIG. 5B.

In embodiments where the central shaft 20 includes such a shoulder (or “step”) 42, the mount portion 54 of a bracket 26 can bear directly against this shoulder. (The mount portion 54 of such a bracket 26 may also bear against the outer face 44 of the second annular inner race body 18B.) As a result, when the lock nut 36 or other locking means are tightened, it is possible to avoid having more compression force than intended delivered to the inner race 18 from the mount portion 54 of the bracket 26. This may be advantageous for the present trolley wheel 12, since the inner race 18 comprises polymer. An arrangement of this nature can elegantly provide polymer inner race performance while simultaneously protecting such an inner race from increased compression forces caused by overtightening a lock nut or other locking means.

The number and size of the ball bearings can vary depending upon the specific embodiment. In one non-limiting example, there are 14 ball bearings for each of the two rows of ball bearings 16A, 16B (i.e., 28 total ball bearings), and they are ¼ inch diameter stainless steel balls (e.g., AISI 420 SS). For one such wheel assembly, the length of the central shaft 20 is 2.020 inches, and the diameter of the inner race 18 is 1.51 inches. Furthermore, the wheel body can optionally have an outer diameter of 60 mm, or 48-50 mm, as nonlimiting examples.

In some embodiments where the wheel body 14 and the inner race 18 both comprise polymer, the first and second rows of ball bearings 16A, 16B are metal (e.g., stainless steel) ball bearings. In one example, the ball bearings are formed of a hardened martensitic AISI 420 stainless steel, although various steel materials can be used.

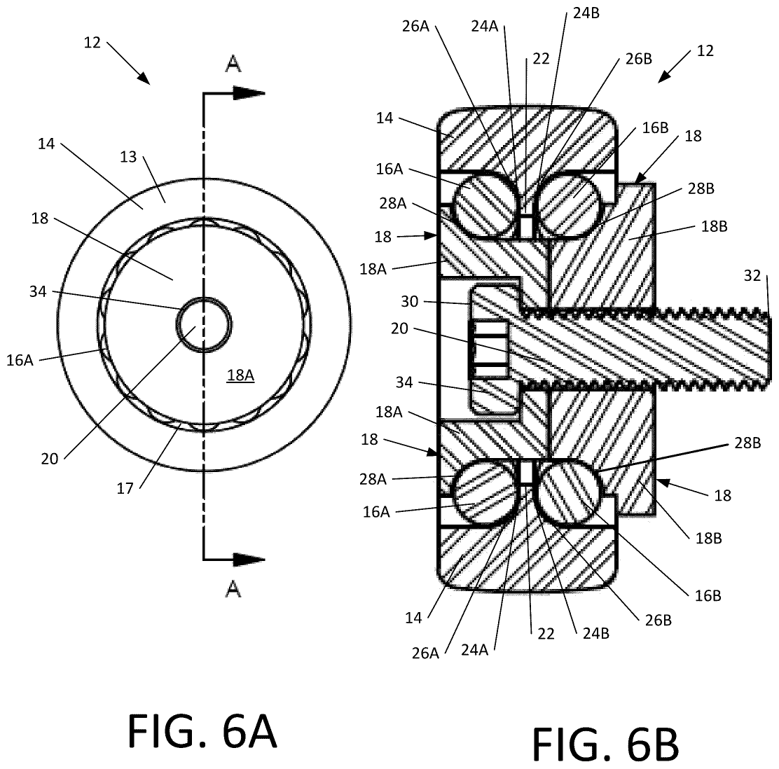

As noted above, the trolley wheel 12 is configured for use in a conveyor system, such as an overhead conveyor system. The assembly shown in FIGS. 1A and 1B can form part of a trolley assembly configured to ride on a track (e.g., a bottom surface of an I-beam) of an overhead conveyor system. Such an overhead conveyor system can, for example, be located in a poultry processing facility. As just one non-limiting example, reference is made to FIG. 6 of U.S. Pat. No. 8,702,178 and the related detailed description section, which are hereby incorporated by reference. Thus, the trolley wheel 12 and assembly 10 of the present disclosure can be used in a trolley assembly like that shown in FIG. 6 of U.S. Pat. No. 8,702,178. This is merely one example; it will be appreciated that the present trolley wheel 12 can be used in various other trolley assemblies. As will be appreciated by those of skill in the present field, the trolley assembly can advantageously include a chain drive mechanism.

In certain embodiments, the inner race 18 and the wheel body 14 both comprise (or consist essentially of, or consist of) polyoxymethylene. This can optionally be in combination with the two rows of ball bearings 16A, 16B comprising non-metal (e.g., ceramic) ball bearings. Additionally or alternatively, each of the two rows of ball bearings 16A, 16B can optionally be devoid of a ball retainer.

With respect to the embodiment shown in FIGS. 6A and 6B, the inner race 18 is a split inner race comprising first 18A and second 18B annular inner race bodies. Here, the first annular inner race body 18A is carried against the second annular inner race body 18B at an interface therebetween, which interface lies in a plane that passes through the second row of ball bearings 16B. In this non-limiting example, an entirety of the flat top of the butte configuration of the illustrated wheel body's central rim 22 is located directly radially outward of the first annular inner race body 18A. It is to be appreciated, however, that the interface can alternatively be midway between the two rows of ball bearings, e.g., as shown in the non-limiting examples of FIGS. 1B, 3B, and 5B.

Furthermore, the embodiment of FIGS. 6A and 6B can alternatively have a sloped outer tread surface, as shown in FIGS. 1B, 3B, and 5B. Moreover, any of the embodiments of FIGS. 1B, 3B, and 5B can alternatively have a non-sloped tread surface, as shown in FIGS. 6A and 6B. It will be appreciated by a person of ordinary skill in this field that the configuration of the tread surface can be designed to accommodate different types of conveyor tracks.

In terms of manufacturing, the wheel body and the inner race can generally be machined or injection molded (as appropriate given the material(s) selected) so as to have the desired profiles. The central shaft (optionally formed of stainless steel or plated carbon steel) can be machined or cold formed so as to have the desired geometry, preferably including a knurl around the central shaft to engage with the polymer inner race so as to prevent rotation of the inner race relative to the central shaft. The first annular inner race body can then be installed with a press fit onto the central shaft and set in tooling such that the central shaft projects straight upward. The wheel body can then be positioned around the central shaft but held up high enough to leave space for loading the ball bearings. The wheel body can be dropped, after the first row of balls has been loaded, to encapsulate them. The second row of balls can then be loaded in the second race of the wheel body. Finally, the second annular inner race body can be installed onto the central shaft with a press fit to hold the trolley wheel together before final installation to its mating trolley bracket using a nut or by staking it to the trolley bracket.

Although various embodiments have been described with reference to preferred implementations, persons skilled in the art will recognize that changes may be made in form and detail without departing from the spirit and scope thereof.

What is claimed is:

1. A trolley wheel for use in a conveyor system, the trolley wheel comprising a central shaft, a wheel body, first and second rows of ball bearings, and an inner race, the wheel body and the inner race both comprising polymer in combination with the trolley wheel being devoid of a metal inner race and being devoid of a metal outer race, the wheel body defining a central rim with opposed first and second sides that respectively define first and second outwardly-angled outer race tracks, the inner race defining first and second inwardly-angled inner race tracks, such that the first row of ball bearings is configured to roll between the first inwardly-angled inner race track and the first outwardly-angled outer race track, and the second row of ball bearings is configured to roll between the second inwardly-angled inner race track and the second outwardly-angled outer race track.

2. The trolley wheel of claim 1 wherein the inner race is a split inner race consisting of first and second annular inner race bodies mounted side-by-side on the central shaft, the central shaft having opposed first and second ends, the first end of the central shaft having an enlarged head, the first annular inner race body being adjacent to the enlarged head of the central shaft, and the trolley wheel being devoid of a retainer hub alongside the second annular inner race body.

3. The trolley wheel of claim 2 wherein the trolley wheel is mounted on a trolley bracket, such that that the second annular inner race body is carried directly alongside the trolley bracket.

4. The trolley wheel of claim 2 wherein the first and second annular inner race bodies mounted side-by-side on the central shaft are mounted thereon solely by a press fit of the first and second annular inner race bodies on the central shaft.

5. The trolley wheel of claim 1 wherein the inner race has a first thickness, the wheel body has a second thickness, and the first thickness is greater than the second thickness, the first and second thicknesses measured along a rotation axis along which the central shaft is elongated.

6. The trolley wheel of claim 1 wherein the inner race comprises a first polymer, the wheel body comprises a second polymer, and the first polymer is a different polymer than the second polymer.

7. The trolley wheel of claim 6 wherein the first polymer comprises ultra-high molecular weight polyethylene.

8. The trolley wheel of claim 7 wherein the second polymer comprises polyoxymethylene.

9. The trolley wheel of claim 1 wherein the inner race is a split inner race comprising first and second annular inner race bodies, the first and second annular inner race bodies both being machined polymer bodies, whereas the wheel body is an injection molded polymer body.

10. The trolley wheel of claim 1 wherein the inner race is a split inner race comprising first and second annular inner race bodies, the first annular inner race body being carried against the second annular inner race body at an interface therebetween, the interface lying in a plane that passes through the second row of ball bearings.

11. The trolley wheel of claim 1 wherein the first and second rows of ball bearings are devoid of a ball bearing retainer, and the first and second rows of ball bearings comprise non-metal ball bearings.

12. The trolley wheel of claim 11 wherein the non-metal ball bearings are formed of ceramic.

13. The trolley wheel of claim 12 wherein the central shaft is formed of metal, and the trolley wheel is characterized by having a wheel face consisting of, moving radially outwardly, a circular metal face portion defined by the metal of the central shaft, an annular polymer inner face region defined by the polymer of the inner race, and an annular polymer outer face region defined by the polymer of the wheel body, and wherein a gap exists between the annular polymer inner face region and the annular polymer outer face region, such that the first row of ball bearings defines ceramic ball bearing surfaces that are exposed through the gap at the wheel face.

14. The trolley wheel of claim 1 wherein the trolley wheel consists of the central shaft, the wheel body, the first and second rows of ball bearings, and the inner race.

15. The trolley wheel of claim 1 wherein the wheel body and the inner race are both formed of ultra-high molecular weight polyethylene.

16. The trolley wheel of claim 1 wherein the wheel body and the inner race each have a dynamic coefficient of friction that is less than 0.25.

17. The trolley wheel of claim 1 wherein the central shaft is elongated along a rotation axis, and a radial axis perpendicular to the rotation axis passes midway between the first and second rows of ball bearings, the first inwardly-angled inner race track and the first outwardly-angled outer race track being aligned along a bearing angle, such that the bearing angle is offset from the radial axis by an acute angle.

18. The trolley wheel of claim 17 wherein the acute angle is between 30 degrees and 60 degrees.

19. The trolley wheel of claim 1 wherein the central rim has a butte configuration characterized by: (i) a flat top facing radially inwardly toward the inner race, and (ii) first and second sides that extend into divergent first and second curves respectively defining the first and second outwardly-angled outer race tracks.

20. The trolley wheel of claim 19 wherein the inner race is a split inner race comprising first and second annular inner race bodies, and an entirety of the flat top of the central rim's butte configuration is located directly radially outward of the first annular inner race body.

21. The trolley wheel of claim 1 wherein the polymer of the inner race comprises a lubricant additive.

22. The trolley wheel of claim 21 where the polymer of the wheel body is devoid of the lubricant additive.

23. The trolley wheel of claim 21 further comprising a transfer film on the first and second outwardly-angled outer race tracks, the transfer film comprising the lubricant additive.

24. The trolley wheel of claim 21 wherein the lubricant additive is selected from the group consisting of molybdenum disulfide, tungsten disulfide, graphite, calcium stearate, polytetrafluoroethylene, and oil.
